(19) United States
(12) Patent Application Publication
(10) Pub. No.: US 2009/0302166 A1
(43) Pub. Date: Dec. 10, 2009

(54) Space station, launch vehicle, and method of assembly

(76) Inventor: Eugene Walter Meyers, West Covina, CA (US)

Correspondence Address: ANDREWS KURTH LLP, 1350 I STREET, N.W., SUITE 1100, WASHINGTON, DC, 20005, US

(21) Appl. No.: 12/155,605

(22) Filed: Jun. 6, 2008

(51) Int. Cl. B64G 1/00

(52) U.S. Cl. 244/158.9; 244/159.4; 244/171.3; 244/172.3; 244/172.7

(57) ABSTRACT

A launch vehicle for a space station includes a crew transport vehicle having an orbiter, a cylindrical cargo module separable from the orbiter when in low earth orbit, and a first liquid fuel rocket engine section coupled to the cargo module operable to assist in placement of the launch vehicle in low earth orbit. The first engine section is separable from the cargo module in low earth orbit. The launch vehicle also includes booster rockets operable to place the launch vehicle in low earth orbit, and a liquid fuel tank, which is convertible to form living and working spaces for the space station. The space station includes rentable space that is used to recover launch and assembly costs associated with the space station.

### BACKGROUND

One limitation to placing spacecraft into orbit, or for that matter, sending space involves the daunting challenge of assembling smaller components, launched from the craft beyond earth orbit, has been vehicle launch weight. Another limitation earth's surface, into a larger assembly.

Initially, space stations were proposed which were to be completely assembled on earth and then launched into orbit. Typically, these space station designs included interconnected sections capable of being collapsed and stored in the payload compartment of a multistage launch vehicle, launched into planetary orbit, and erected in an operative configuration once orbit was achieved.

Various of these proposed space station configurations comprise inflatable structures collapsible to facilitate launching the structure into space and thereafter erectable to form the space station. One disadvantage of the inflatable space station configuration is that installation of equipment is required after erection of the space station in orbit. Another disadvantage of the inflatable space station configuration is potential damage or destruction caused by micro-meteoroid penetration.

Other configurations for a preformed space include those disclosed in Berglund, U.S. Pat. No. 3,169,725, and Nesheim, U.S. Pat. No. 3,332,640. Both patents disclose manned space stations including rigid sections collapsible for orbital deployment and thereafter erectible to an operative configuration. Although these space stations constructed of rigid sections allow pre-installation of equipment on earth and ameliorate the micro-meteoroid damage problem, the size and weight of such rigid body space stations is presently limited by the amount of payload that can be launched at one time into orbit by known launch vehicles. One result is that such rigid body space stations are not sufficiently large to allow gravity simulation at low rotational speeds.

Berglund and Nesheim also allude to launching a number of small units into orbit and assembling the units together to form a space station. These patents, however, mention various problems with regard to such a space station configuration, namely, total fuel requirements for deploying numerous units, rendezvous of the various units launched into orbit, and difficulty with actual assembly of the various units in space.

Nevertheless, Hogan, U.S. Pat. No. 4,057,207, and Johnston et al., U.S. Pat. No. 4,122,991, undaunted by the problems mentioned in Berglund and Nesheim, disclose space stations constructed from modules or materials launched into space at different times. Hogan discloses a space station constructed from modules adapted to be transported by a space shuttle to a predetermined earth orbit and there joined by a number of other space vehicle modules and all connected together to form a pressure tight space station equipped to support a crew for an extended period of time and large enough to generate simulated gravity at low rotational speeds. Johnston discloses an apparatus, referred to as a space spider, for producing a space structure in space from prepunched ribbon or sheet material transported from the earth to the spider at different times by a space shuttle, for example; and, typically, a preformed core is utilized for starting the spinning of the desired space structure. Johnston discloses a conical space structure attached to a single expended external tank of a space vehicle, such as used by a space shuttle. Unfortunately, material for construction of the space stations disclosed in Hogan, and Johnston is transported as payload, such that substantial amounts of fuel are consumed to transport materials to the site of assembly of the space station, which dramatically escalates the cost of construction.

By way of further background, the space shuttle is a space transportation vehicle in which space crews use the spacecraft orbiter again and again in launches from the earth. The space shuttle is comprised of an orbiter having main rocket engines, which carries the crew and payload, a large external tank that contains the propellants for the main engines of the orbiter, and two solid rocket boosters. The orbiter and rocket boosters are reusable, but the external tank is discarded after each launch. The external tank breaks apart and burns in the upper atmosphere of the earth, and the surviving pieces plunge into the ocean.

The two solid rocket boosters are attached to the external tank so that the thrust from the rocket boosters is transmitted to a cylindrical intertank structure from two forward attaches. The aft attaches of the rocket boosters are hinged to the rear wall of the external tank so as to provide lateral rigidity only and do not transmit the thrust of the solid rocket motors.

Also, Salkeld, U.S. Pat. No. 3,955,784, and von Pragenau, U.S. Pat. No. 4,452,412, disclose various configurations for propellant tanks on a spacecraft, such as a space shuttle. Salkeld discloses plural on-board propellant tanks incorporated into the body of the spacecraft so that all propellant tanks are reused during subsequent launches. von Pragenau discloses a more typical space shuttle configuration, including an orbiter releasably mounted to an external tank and further including two rocket boosters detachably connected to the external tank. As in the case of the space shuttle, von Pragenau discloses that the rocket boosters are reused, but that the external tank is jettisoned and breaks apart and burns upon reentry into the atmosphere.

### SUMMARY

What is disclosed is a launch vehicle for a space station. The launch vehicle includes a crew transport vehicle that has an orbiter, a cylindrical cargo module separable from the orbiter when in low earth orbit, and a first liquid fuel rocket engine section coupled to the cargo module operable to assist in placement of the launch vehicle in low earth orbit. The first engine section is separable from the cargo module in low earth orbit. The launch vehicle also includes booster rockets operable to place the launch vehicle in low earth orbit and a liquid fuel tank. The liquid fuel tank includes a first tank containing an oxidizer, a second tank containing a fuel, an intertank structure coupling the first and the second tanks, wherein the first tank is separable from the second tank and the intertank structure is separable from the second tank, and a second liquid fuel rocket section coupled to the second tank and operable to assist placing the launch vehicle in low earth orbit, wherein the second tank and the cargo module when placed in orbit comprise components of the space station.

The herein disclosed space station is useable as an assembly point for other space-based structures and craft. In addition, the space station can house several to hundreds or thousands of people. The space station may be used for government of commercial research purposes, as a space-based resort or hotel, and as a zero gravity or low gravity sports facility. To recover the cost of launch and construction of the space station, space in the space station may be rented or sold to government of commercial entities for any of the above purposes. To reduce launch and construction costs, much of the space station is construction from reuseable components of the launch vehicle.

### DESCRIPTION OF THE DRAWINGS

The detailed description will refer to the following drawings in which like numbers refer to like items, and in which:

FIG. 1A illustrates an exemplary launch vehicle used to provide components for the space station;

FIG. 1B illustrates components of an external tank used with the launch vehicle of FIG. 1A;

FIG. 1C is a side view of the launch vehicle of FIG. 1A

FIG. 2 illustrates an exemplary component of a space station after conversion from a launch vehicle; and

FIGS. 3-6 illustrate an exemplary arrangements of the components of FIG. 2;

FIG. 7 illustrates a space-based solar power system.

### DETAILED DESCRIPTION

What is disclosed is a space station whose basic structure is assembled in orbit from various launch vehicle components. Such components include fuel tanks, rocket engines, and crew and cargo modules. The space station is constructed, maintained and operated in low-earth orbit. The space station can be used for scientific purposes and also can be used as an assembly point for a geosynchronous-orbit satellite or station or for a space vehicle designed to leave earth orbit. The space station also can be used for a variety of novel purposes such as a vacation resort and a zero gravity sports complex, for example.

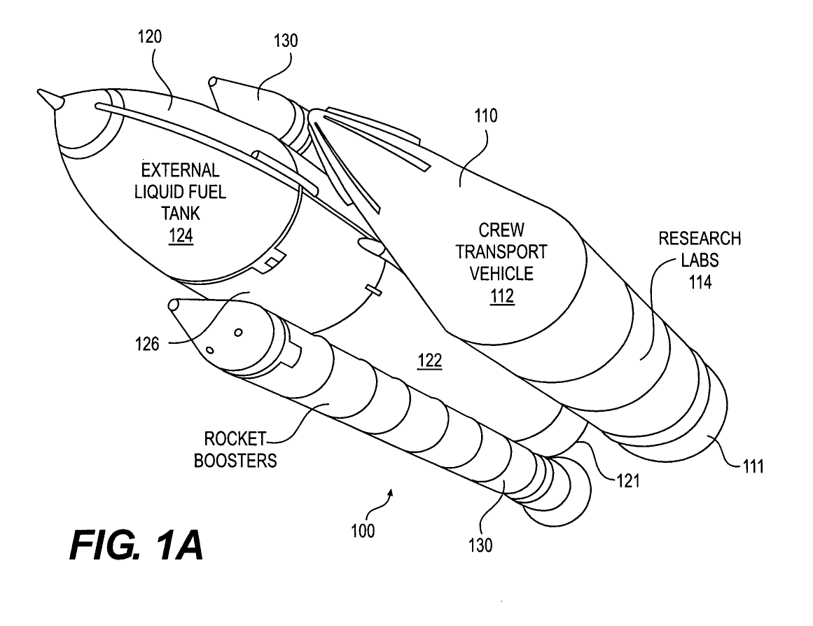

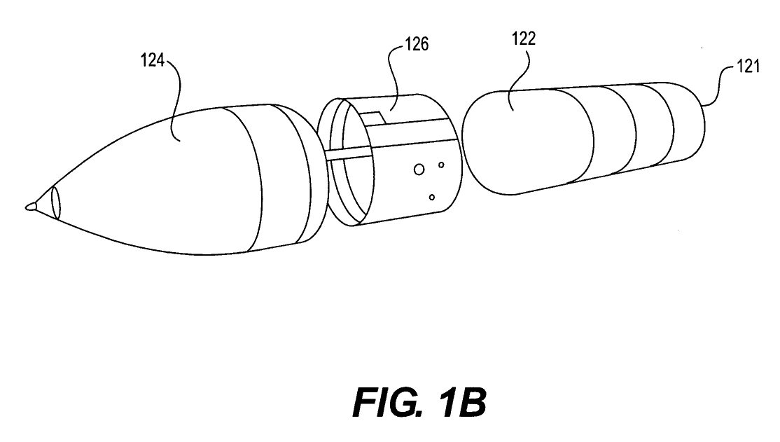

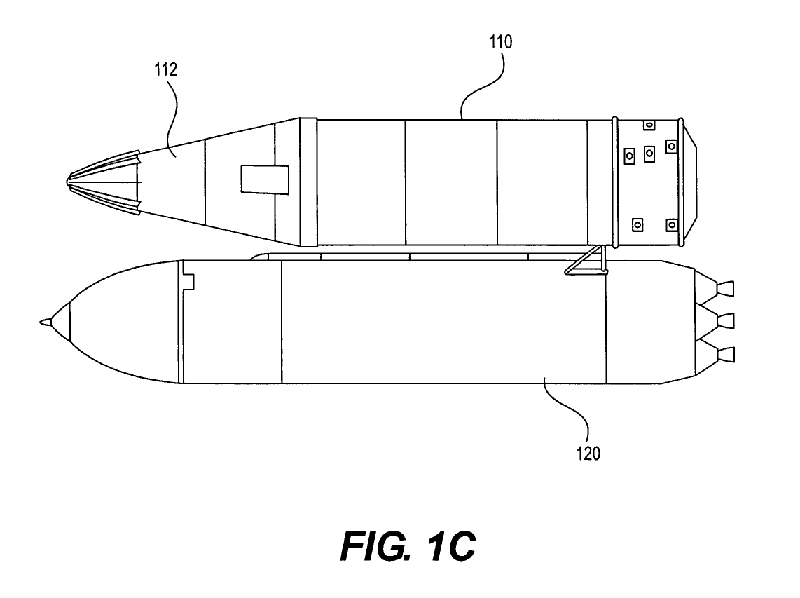

FIG. 1A illustrates an exemplary launch vehicle 100 used to provide components for a space station. One aspect of the launch vehicle 100 is that its launch costs can be recovered by leasing space at a low-earth space station that would be constructed from a combination of materials carried by the launch vehicle as well as reuseable components of the launch vehicle 100 itself. Such lease may be for the purpose of construction of other space stations (e.g., the geosynchronous station), a space craft, or to conduct various commercial and scientific activities in low earth orbit. Such commercial activities include assembly of components in a vacuum condition, zero gravity sporting events, and a space-based hotel, for example. Scientific activities include government and private industry research.

As shown in FIG. 1A, the launch vehicle 100 includes crew transport vehicle 110 (which has an optional orbiter), external liquid fuel tank 120, and rocket boosters 130, all coupled as shown. The external fuel tank 120 and the rocket boosters 130 may detach from the crew transport vehicle 110 at specific points in flight.

The crew transport vehicle 110 includes optional orbiter 112 to which is coupled a cargo module 114. In an embodiment, the cargo module 114 is configured as a research laboratory. In another embodiment, the cargo module 114 contains, inter alia, components needed for the space station to complete its assigned mission. For the example, such components may include a solar collector used to collect solar energy for conversion to electricity to power a space station. The module 114 also may be outfitted as living quarters, or other configurations, for the space station. As thus outfitted, the module 114 may be used to support commercial activities.

Finally, the crew transport vehicle 110 includes liquid rocket motor 111 draws fuel from tanks (not shown) internal to the vehicle 110.

Normally, the launch vehicle 100 (in a manned configuration) is controlled by humans and supporting computer systems located in the orbiter 112. The vehicle 100 also may be launched in an unmanned mode, with control exercised from a ground launch station (not shown) and optionally with terminal control exercised from an orbiting structure.

For some launch configurations, the orbiter 112 may be omitted, and just the originally-sized module 114 included. In these configurations, the launch vehicle 100 is, of course, unmanned. When an unmanned launch is used, the module 114 may be replaced with a larger version of the module 114.

In an exemplary configuration of the launch vehicle 100, the liquid fuel tank 120 has a diameter of 28 to 33 feet and a length of 180 feet. The attached crew transport vehicle also has a diameter of about 28 to 33 feet and an overall length of up to 180 feet. However, in the manned version of the launch vehicle 100, the module 114 has a length of about 120 feet, and the orbiter 112 has a length of about 60 feet. In the unmanned version, with the orbiter 112 deleted, the module 114 has a length approximately equal to that of the liquid fuel tank 120.

The liquid fuel tank 120 includes an oxidizer tank and a fuel tank. Fluids from the two tanks mix to fuel to the main engines 111 of the crew transport vehicle 110. The liquid fuel tank 120 also includes liquid fuel rocket engines 121, which also draw fuel from the tank 120. Once the crew transport 110 vehicle reaches the desired altitude, the liquid fuel tank 120 separates and is used as part of a space station. When used as a component of a space station, the liquid fuel tank 120, once separated from the crew transport vehicle 110, may be positioned into roughly final orbital position by the engines 121. Alternately, both the liquid fuel tank 120 and the crew transport vehicle 110 may proceed to roughly the final orbital position using the engines 121 and the engines 111. In yet another configuration, the module 114 and the liquid fuel tank 120 proceed to final orbital position while the orbiter 112 returns to the earth's surface under its own power.

The rocket boosters 130 may be solid or liquid rockets. The rocket boosters 130 normally fall back to earth after use, and are recovered and reused.

FIG. 1B illustrates components of the external tank 120. More specifically, in an embodiment, the external tank 120 includes a hydrogen tank 122, a liquid oxygen tank 124, and a cylindrical intertank 126. The liquid oxygen tank 124 is a butt fusion welded gas-type pressure vessel of aluminum alloys. Aluminum plates are shaped and chemically milled to form an ogive-shaped forward end joined to a cylinder, and the aft-tank end is closed with a modified ellipsoidal dome.

Intertank 126 is a cylindrical structure of stringer stiffened panels joined to ring frames. A booster rocket beam extends across the diameter of intertank 126 and transmits the thrust generated by the rocket boosters to the launch vehicle 100.

After being placed in low earth orbit in conjunction with the launching of an orbiter 112, the external tank 120 is preferably stabilized in orbit during disassembly operations using a space station based orbital-maneuvering vehicle. Alternatively, a single launch of an orbiter is used to place the external tank 120 in orbit where orbiter astronauts then perform the disassembly operations. The disassembly operation may include the separation of hydrogen tank 122 from oxygen tank 124 and intertank 126 by extravehicular activity.

Separation of hydrogen tank 122 from intertank 126 and oxygen tank 124 is a complicated process that involves disassembly of large mechanical joints. This separation process further requires venting and purging the liquid oxygen tank and feed line; draining, venting and purging of the liquid hydrogen tank; and removing of the explosive charges of the range-safety system. To avoid these complications, in an embodiment, the hydrogen tank 122, liquid oxygen tank 124, and intertank 126 may remain bolted together and form a base structure for the space station.

To facilitate crew access to empty sections of the oxygen tank 124, the intertank 126 and/or the hydrogen tank 122, in orbit, one or more hatches may be built into the adjacent walls of the fuel tank 120 and the cargo module 114 before launch.

FIG. 1C is a side view of the launch vehicle 100.

Docking modules may be provided for interconnection of a plurality of hydrogen tanks 122 (such as in tandem). A variation of the docking module DM-2 used in connection with the Apollo-Soyuz Test Program (ASTP), for example, can be used as a docking module for interconnection of the hydrogen tank 122 in tandem with other similar hydrogen tanks. Alternatively, the docking modules can be incorporated into the forward end and the aft end of the hydrogen tank 122, which are exposed for operative interconnection of the tank 122 with other tanks 122 during construction of the space station.

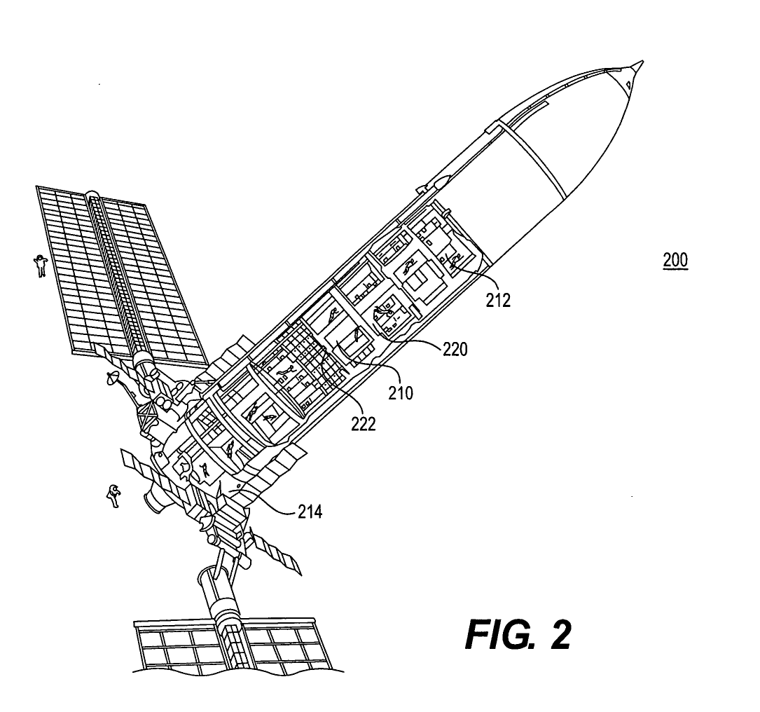

FIG. 2 illustrates an exemplary modular space station structural building component 200 of a space station after conversion from a launch vehicle 100. The component 200 may be constructed from either the fuel (i.e., hydrogen or some other fuel) tank 122 or from the cargo module 114. The component 200, as illustrated, includes habitable spaces 210 that are defined by decks 220 and an outer wall of the component 200. The habitable spaces 210 as illustrated include living quarters for the space station crew, work spaces, and storage spaces. Movement of personnel between the habitable spaces 210 is by way of hatches 222. The hatches may be essentially gas tight so that a leak in one habitable space can be isolated by shutting the fore and aft hatches associated with that space. Access to the component 200 from outside is by way of fore and aft airlocks 212 and 214. As shown in FIG. 2, the decks 220 are preferably pre-installed while the component 200 (in its guise as fuel tank 122 or cargo module 114) is on earth, thereby alleviating the need to install these structures after orbital deployment. Such pre-installation may take the form of simply staging the decks 220 within the shell of the component 200. The walls of the component 200 would then include deck clips into which the staged decks 220 are inserted once the component is in orbit. Alternatively, such pre-installation may take the form of final assembly of the decks 220 into the component 200 prior to launch.

The hatches may be pre-installed in the decks 220, or in the case of the hydrogen tank 122, may simply be stored within the tank 122 for later deck installation once the tank 122 is in the desired orbital position. Furthermore, various other equipment (not shown), which, in the case of the fuel tank, are not damaged through contact with the fuel, can also be pre-installed on the earth prior to orbital deployment. Additionally, the cargo module 114 can serve to transport as payload various equipment needed for deployment of the hydrogen tank 122 as the modular space station structural building component 200. The equipment contained in the payload compartment can include facilities for conversion of the tank 122 into living quarters, a communication center, or a laboratory, for example.

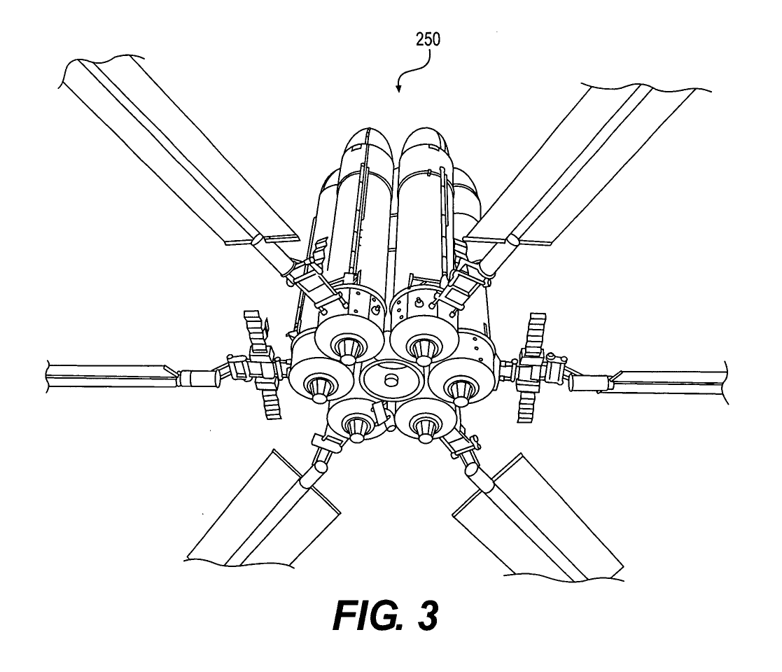

FIGS. 3-6 illustrate exemplary arrangements of the space station 200 of FIG. 2. Any of the exemplary arrangements of the space station 200 primarily may be constructed after the components have been boosted to low earth orbit.

In FIG. 3, space station 250 is shown to be fabricated from several reuseable components of the launch vehicle 100 of FIG. 1A, specifically external liquid fuel tank components 122/124/126, formed in a central arrangement with solar collectors to provide electrical power to the station. The station 250 would not have any artificial gravity.

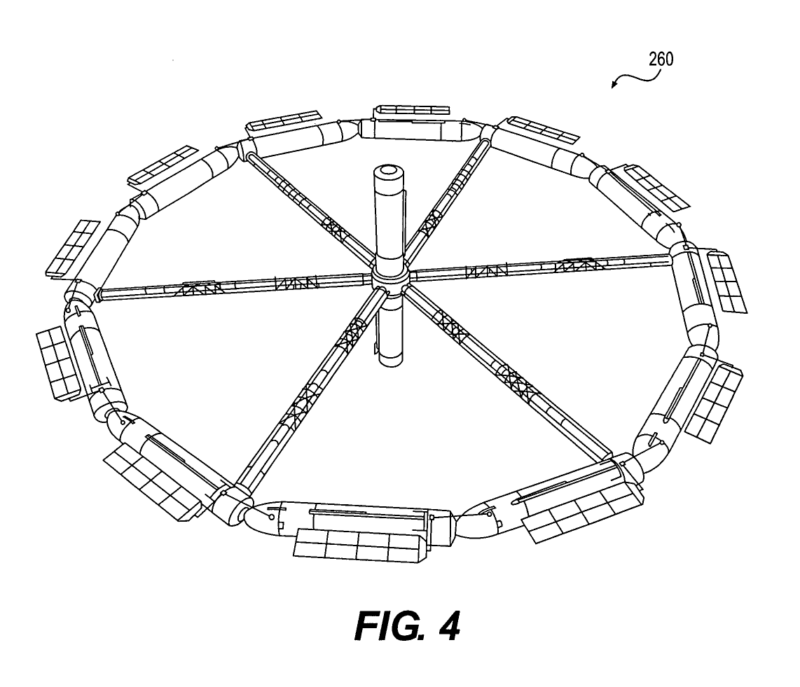

In FIG. 4, several external liquid fuel tanks are assembled “nose to nozzle” in a ring arrangement to form station 260, at the center of which may be installed one or more lab components 114, or, alternatively, liquid fuel tanks. The advantage of station 260 is that it may be spun at low speed to create artificial gravity in the outer ring areas.

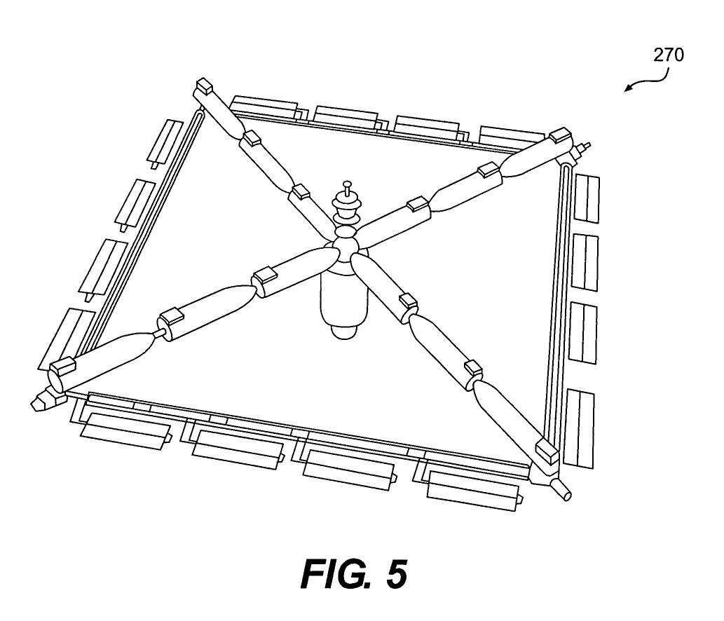

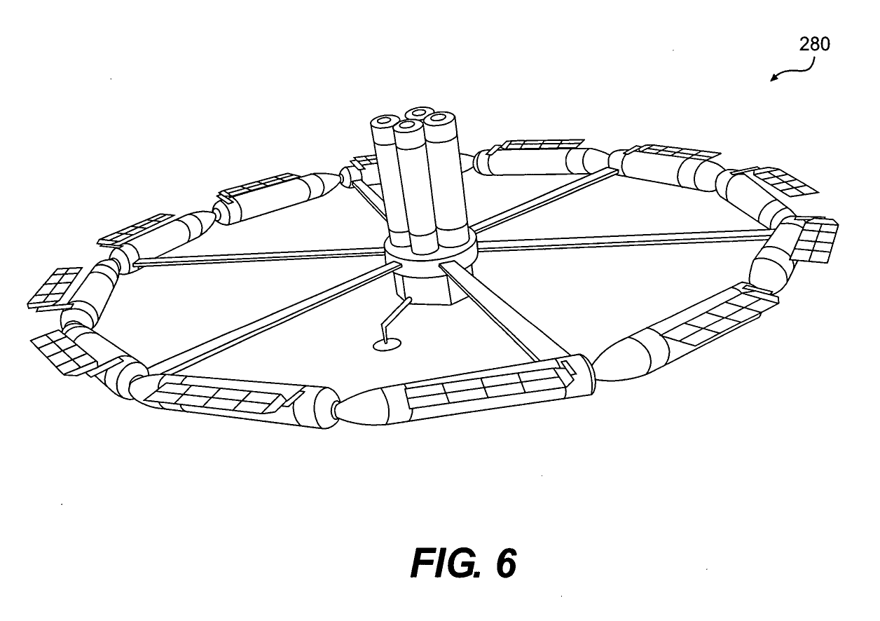

FIGS. 5 and 6 show two alternate ring structured space stations 270 and 280, respectively, that may be spun a low speed to generate an artificial gravity.

One use of the space stations of FIGS. 2-6 is to serve as an assembly point for a geosynchronous-orbit space-based solar power station. Such a space-based solar power station could help solve many of the word's energy supply issues. For example, in some countries, as much as 50 percent of the population has no access to electricity. Building electrical power supply infrastructure for these population segments is costly in terms of dollars and in terms of environmental impacts. Moreover, development of this infrastructure could take decades. Even so, some remote population segments may never receive electrical power given present day means for distributing electricity, the paradigm of which is a central power station feeding a grid with further distribution to substations and individual consumers using above and below ground transmission means (e.g., towers, cable). A further drawback of some current electrical power distribution means is the environmental impact of operation, namely burning fossil fuel or generation of nuclear waste. Power generation systems that use solar energy and wind power are known, but these generally do not generate large quantities of power, and the infrastructure associated with each also can be expensive to construct. Solar power generators have the additional feature of not operating well in other than bright daylight conditions. The following table shows the amount of power that can be received per square meter of solar cell, depending on the solar cell's location.

TABLE 1
Average Power Received by a Solar Cell

| | Power per |
|---|---|
| Location | square meter |
| In outer space, above the Earth's atmosphere | 1 400 W/m² |
| Strong vertical sun at mid day in a tropical country, | 950 W/m² |
| clear sky | |
| Year average in US or Europe | 200 W/m² |
| Fraction that can be converted into electricity | <100 W/m² |
| (year average in US or Europe) | |

As Table 1 shows, a solar power collector located in outer space can receive much more solar power than a corresponding collector on the earth's surface. Unfortunately, locating a solar power station in outer space is an expensive and complicated endeavor. Fortunately, the herein described methods, systems, and devices can be used to overcome the problems associated with a space-borne solar power station.

A space-based solar power station may use any known solar collector technology. For example, typical solar cells are made from silicon that has been altered to form two different types of semiconductor material. These two types of silicon are then joined in such a way as to form a junction. Due to the different types of semiconductor material that make up this junction, a permanent electric field is forced to appear in this region. When a photon from a light source such as the sun strikes the cell, it causes an electron in the semiconductor material to jump to a higher orbit and jump from atom to atom. The permanent electric field forces the electron to move only in a particular direction, out of the cell and through a circuit such as a light bulb, a motor or battery etc. and then back to the other side of the junction thus performing work. By connecting cells together to form a solar panel, even more work can result. The typical individual silicon solar cell has the potential of generating about half a volt, but by wiring such cells in series or end to end, the voltage output can be increased.

Once the solar power is collected in outer space, some mechanism must be used to get that power to the earth's surface. Microwave power transmission (MPT) is the use of microwaves to transmit power through outer space or the atmosphere without the need for wires. The idea of radio power transmission was first conceived by Tesla about a century ago. However, the first practical use of radio waves was for transmitting intelligence and information, and not for transmitting electrical power per se. At the close of World War II, engineers and scientists re-examined the original Tesla idea of transmitting electric power to a distant place via radio, as high-power microwave technology became available. In 1964, William C. Brown demonstrated a miniature helicopter equipped with a combination antenna and rectifier device called a rectenna. The rectenna converted microwave power into electricity, allowing the helicopter to fly. In principle, the rectenna is capable of very high conversion efficiencies—over 90 percent in optimal circumstances.

Most proposed MPT systems now usually include a phased array microwave transmitter. While these have lower efficiency levels, they have the advantage of being electrically steered using no moving parts, and are easier to scale to the necessary levels that a practical MPT system requires.

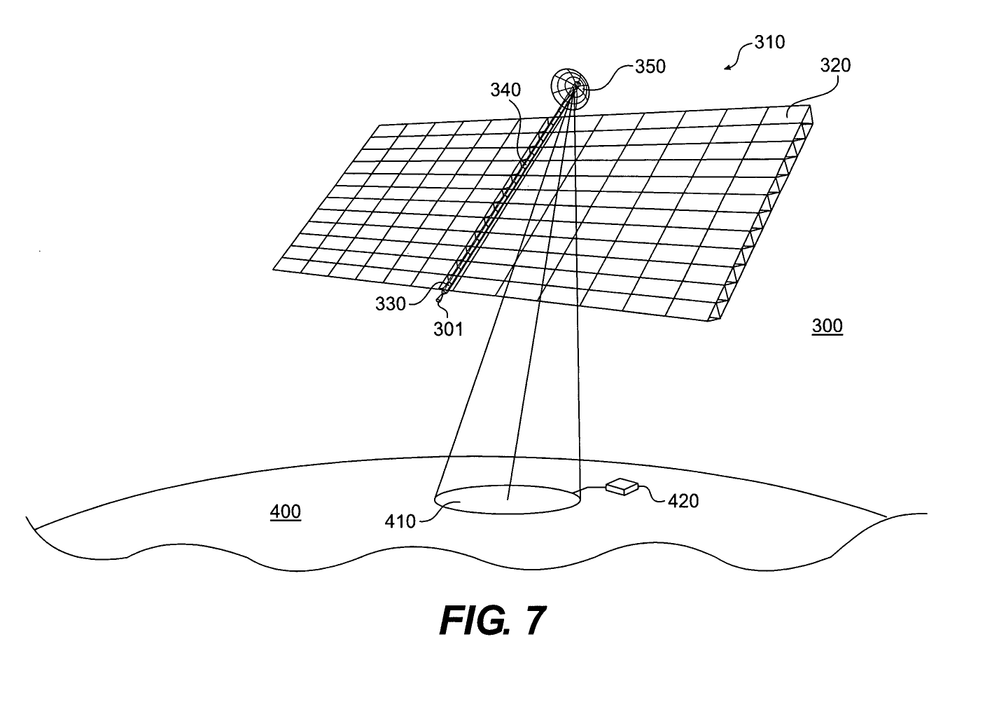

FIG. 7 illustrates selected components of a solar power system 300 that overcomes the disadvantages of many current power distribution systems, makes space-based solar power commercially viable, and makes electrical power practically available to any population segment. The system 300 includes unmanned space-based solar power station 310, operating in geosynchronous orbit after assembly at low earth orbit and boost to its final orbital position. The station 310 includes space-based solar collector 320. The solar collector 320 comprises a large array, perhaps a mile or more square, of individual solar collectors. The solar collector 320 connects to power conditioner 330. The power conditioner 330 connects to microwave generator 340. The generator 340 connects to microwave transmission system 350. These components are used to convert solar power to electricity, and electricity to microwaves. The system 350 sends low energy microwaves to ground station 400.

The space-based solar power station 310 operates in a geosynchronous orbit, meaning it is located at a fixed point above earth. To achieve this geosynchronous orbital position, the various components of the power station 310 must be boosted well beyond the current low earth orbital position of space shuttles. Specifically, the components must be boosted to an altitude of about 22,500 miles instead of the typical 160 mile altitude of the space shuttle. However, construction activities for the power station 310 occur at low earth orbit, with the components then moved to a higher orbital position by ion motor 301.

The ground station 400 includes receiving antenna system 401, electrical generator system 410 that converts the received microwaves into electricity. The receiving antenna is oval-shaped, assuming the receiving antenna system 410 is located off the equator, and will have to be large enough to account for spreading of the low energy microwaves during transmission to earth. As a result, the “footprint” of the antenna system 401 is likely to be comparable in size to the solar collector 320. The system 410 connects to electrical power distribution system 420, which transfers electrical energy to entities located outside the system 300. The orbital location of the power station 310, of course, places many design constraints on the ground system 400. For example, moving ground station 400 off the equator changes the shape and angle of the low energy microwave beam received at the earth's surface.

The space station 200 of FIG. 2 also may be used for other assembly procedures, such as assembly of space craft (manned or unmanned) to explore other parts of the universe, as well as repair operations for other satellites. The space station 200 of FIG. 2, or any of the stations illustrated in FIGS. 3-6, may serve various commercial purposes. By renting space in the station 200, the launch costs as well as the assembly costs and other related costs associates with placing a finished space station in orbit can be recovered. For example, up to 95 percent of the cost of the solar power station 310 construction resides in launch costs. By reusing launch components as parts of a space station (e.g., the space station 200) those solar power station 310 construction costs can be lowered dramatically. In addition, revenues derived from operation of a space-based solar power station assembled at the space station 200 (or other low earth orbit station) also can be used to recover the cost of placing the station 200 in low earth orbit.

What is claimed is:

1. A launch vehicle for a space station, the vehicle, comprising:
a crew transport vehicle comprising:
an orbiter,
a cylindrical cargo module separable from the orbiter when in low earth orbit, and
a first liquid fuel rocket engine section coupled to the cargo module operable to assist in placement of the launch vehicle in low earth orbit, wherein the first engine section may be separable from the cargo module in low earth orbit or in geosynchronous orbit;
a plurality of booster rockets operable to place the launch vehicle in low earth orbit; and
a liquid fuel tank, comprising;
a first tank containing an oxidizer,
a second tank containing a fuel,
an intertank structure coupling the first and the second tanks, wherein the first tank is separable from the second tank and the intertank structure is separable from the second tank, and
a second liquid fuel rocket section coupled to the second tank and operable to assist placing the launch vehicle in low earth orbit, wherein the second tank and the cargo module when placed in low earth orbit comprise components of the space station.

2. The launch vehicle of claim 1, wherein the second tank contains one of hydrogen and another fuel as a fuel and the first tank contains liquid oxygen as an oxidizer.

3. The launch vehicle of claim 1, wherein the rocket boosters are liquid fuel rocket boosters.

4. The launch vehicle of claim 3, wherein the rocket boosters are reusable.

5. The launch vehicle of claim 1, wherein the second tank includes a plurality of decks, staged prior to launch of the launch vehicle.

6. The launch vehicle of claim 5, wherein one or more of the decks includes an opening to accommodate a hatch, and wherein the hatch is stored in the second tank for installation into opening upon achieving an orbital position.

7. The launch vehicle of claim 1, wherein the second tank comprises equipment, installed prior to launch, and designed to allow operation of the second tank as a component of the space station.

8. The launch vehicle of claim 1, further comprising components of a space-based solar power station, and wherein the cargo module includes solar collectors and associated equipment to allow collection of solar energy, conversion to microwaves, and transmission to earth.

9. The launch vehicle of claim 1, wherein the cargo module and the liquid fuel tanks are separately operable to achieve a desired orbital position.

10. The launch vehicle of claim 1, wherein components of the launch vehicle are used to assemble a low earth orbit space station, and wherein space on the space station is rentable to commercial and government entities.

11. The launch vehicle of claim 1, wherein the orbiter is designed to operate in low earth orbit to move cargo and personnel during construction of the space station, and wherein the orbiter is capable of return to earth operation.

12. A launch system for placing a space station into earth orbit, comprising:
a first lift unit, comprising:
a separately controllable powered structure capable of achieving at least low earth orbit; and
a second lift unit, comprising:
an oxidizer section,
a fuel section, and
an engine section, wherein the second lift unit supplies fuel to the first lift unit and the second lift unit.

13. The system of claim 12, wherein the fuel section contains one of hydrogen and another fuel as a fuel and the oxidizer section contains liquid oxygen.

14. The system of claim 12 further comprising a plurality of rocket boosters, wherein the rocket boosters are one of liquid and solid fuel rocket boosters.

15. The system of claim 14, wherein the rocket boosters are reusable.

16. The system of claim 12, wherein the second lift unit includes a plurality of decks, pre-installed prior to launch of the second lift unit.

17. The system of claim 16, wherein one or more of the decks includes an opening to accommodate a hatch, and wherein the hatch is stored in the second tank for installation into opening upon achieving an orbital position.

18. The launch vehicle of claim 12, wherein the second lift unit comprises equipment, installed prior to launch, and designed to allow operation of the second as a component of the space station.

19. The launch vehicle of claim 12, wherein the first lift unit includes solar collectors and associated equipment to allow collection of solar energy, conversion to microwaves, and transmission to earth.

20. A launch vehicle for placing components of a space station into orbit, comprising:
first launch means for placing components of the space station into orbit;
second launch means coupled to the first launch means comprising structural components of the space station, the second launch means capable of independent operation to achieve a desired orbital position, wherein the components supplied by the first launch means and the structural components from the second launch means are combined to construct the space station.
